(19) United States
(12) Patent Application Publication
(10) Pub. No.: US 2009/0292624 A1
(43) Pub. Date: Nov. 26, 2009

(54) NETWORKED PRINTING

(76) Inventor: Afshin Mirmotahari, Victoria (CA)

Correspondence Address: Amelia A. Buharin;Patent Legal Staff, Eastman Kodak Company, 343 State Street, Rochester, NY, 14650-2201, US

(21) Appl. No.: 12/123,668

(22) Filed: May 20, 2008

(51) Int. Cl. G06Q 30/00; G06Q 50/00

(52) U.S. Cl. 705/27; 705/26

(57) ABSTRACT

A method and apparatus for ordering printed materials through a network of printing storefronts is presented. Printable products defined in one storefront can be defined by inheriting from products defined in another storefront. Multiple storefronts can collaborate in a virtual print community to enable clients to browse and order products from any storefront in the community.

### CROSS REFERENCE TO RELATED APPLICATIONS

Reference is made to commonly-assigned copending U.S. patent application Ser. No. 11/538,937, filed Oct. 5, 2006, entitled AUTOMATED PRINTING, by McDonald et al.; U.S. patent application Ser. No. 11/678,250, filed Feb. 23, 2007, entitled PRINT PRICING, by Mirmotahari et al.; and U.S. patent application Ser. No. ______ (Attorney Docket No. 95014/NAB), filed herewith, entitled NETWORKED PRINTING, by Mirmotahari; the disclosures of which are incorporated herein.

### FIELD OF THE INVENTION

The present invention pertains to ordering printed materials and in particular to using a network of printing systems to order and fulfill printed materials.

### BACKGROUND OF THE INVENTION

Automation has been an important theme in printing in recent years. Conversion of manual processes to computerized and automated methods has occurred in many areas of print production and has recently extended into the customer-facing processes such as order taking. This is especially so for print orders having relatively small quantities with low profit margins.

Many printing service providers are establishing internet-based storefront presences where print buyers can remotely order from a catalog of pre-defined products. These orderable products can include static products (e.g. forms, postcards) and products that can be personalized or completely specified with buyer-supplied content and intent (e.g. greeting cards, business cards).

Storefront automation can include automatic acquisition of customer content and intent for the pre-defined products as well as automatic generation of pricing and collection of payment. Commonly-assigned U.S. patent application Ser. No. 11/678,250 describes an exemplary storefront for automating the process of ordering pre-defined products and is hereby incorporated by reference. Automatically obtained print orders can then be delivered to a printing system for fulfillment.

Automated fulfillment of print orders can include automated creation of a print job for an order and automated processing of the print job. Commonly-assigned U.S. patent application Ser. No. 11/538,937 describes an exemplary printing system for automating the fulfillment of print orders by generating rules for converting printing intent parameters specified for an orderable product into production processing parameters utilized in print production process, and is hereby incorporated by reference.

These exemplary prior art systems can offer a high degree of automation because they are tightly integrated. For example, the storefront defines an orderable product by defining product characteristics and printing intent parameters whose values are specified by the print buyer. The product definition can also include printing content and/or placeholders for content to be supplied by the print buyer and is shared with the printing system. This product definition forms the basis of other configurable data in the storefront (e.g. pricing rules) and printing system (e.g. production processing rules).

In other words, automation comes at the expense of pre-configuring information that is highly dependent on certain shared information. This level of dependency and sharing is acceptable for organizations that have close relationships and where the volume for a product warrants the configuration expense. However, the marketplace includes a large number of relatively independent organizations, some that have access to a large number of print buyers but have limited printing capabilities (e.g. service bureaus and large corporations), and others such as printing firms that have printing capacity and expertise but a limited client base.

These independent organizations would benefit from the ability to cooperate with each other but the setup costs and potential for errors may make their offering uncompetitive with an integrated vendor. Print buyers would also benefit from easier access to a larger pool of printing services. For example, a print buyer might want to easily search a wide range of catalogs from a number of service providers for a product, such as a greeting card or business card, and compare their offerings. Prior art systems do not allow for such organizational cooperation and flexible print buying experiences with the degree of automation to be competitive with vertically integrated printing service providers.

### SUMMARY OF THE INVENTION

The present invention provides for a network of independent storefront and printing systems to cooperate in providing an automated print procurement process. The network allows the storefronts to provide information about orderable products to other systems in the network so that a print buyer can order a printed product through the network and have it automatically fulfilled by a printing system associated with one of the storefronts on the network.

According to one aspect of the invention, storefront systems can be configured so that a print buyer can order from a second storefront system with the order being automatically subcontracted to a first storefront system for automatic fulfillment by an associated printing system. Orders can be for products or catalog items, for example. Products, in some embodiments, specify the nature of the printed item but do not include printable content. Products associated with content, including content that may require personalization, are typically organized in catalogs and hence are referred to as catalog items. For clarity, the term “product” is used throughout the present application to mean a print product with or without associated content.

According to one aspect of the invention, a product definition at a second storefront can be configured in relation to a product definition configured at a first storefront. This allows, for example, the owner of the second storefront, with access to many clients, to automatically create and subcontract an order to the first storefront, which can be operated, for example, by a printing service provider with a limited client base but with automated printing facilities based on the first storefront's products. The second storefront owner can charge a nominal fee for the order transfer and can incur virtually no transactional cost. The owner of the first storefront can incur virtually no additional configuration costs and benefits from the increased print volume. If the second storefront is operated by an enterprise, such as a large company with an internal client base, their primary benefit in operating a second storefront may be the increased flexibility in configuring new and/or modified product definitions.

According to another aspect of the invention, printing product definitions can be defined based on existing product definitions to simplify the configuration of new products and dependent information. For example, a first print product definition can define a general form of product with many potential options. Then, specialized secondary product definitions can easily be defined by inheriting selected characteristics from the first print product definition. Dependent information, such as pricing and print production rules, can be reused without modification or selected information, like pricing information, can be inherited and specialized as needed.

According to another aspect of the invention, product definitions can be inherited between networked systems. For example, some parts of a product definition from a first storefront can be automatically shared with a second storefront when configuring a subcontracted product definition. The owner of a first system may elect to share selected information with a foreign system. For example, selected pricing information may be shared or no pricing information may be shared.

According to another aspect of the invention, multiple storefronts on a network can be configured to join a print community that enables selected product definitions from a storefront to be visible in the community and orderable through the community. Clients of the community can then browse the community for a wider variety of product offerings and can influence any subcontracting that may be required based on geography, preferred service providers and other characteristics.

According to another aspect of the invention, storefronts participating in the print community can collect and report information related to searches performed by print buyers and interactions between entities in the community. This information may assist a service provider in refining product offerings.

These and other aspects of the present invention will be described more completely in the detailed description.

### BRIEF DESCRIPTION OF THE DRAWINGS

FIG. 1 is a diagram illustrating an exemplary system for automated printing according to the prior art.

FIG. 2 is a diagram illustrating an exemplary network of storefronts according to one embodiment of the present invention.

FIGS. 3A and 3B are diagrams illustrating exemplary print communities according to one embodiment of the present invention.

FIG. 4A is a diagram illustrating an exemplary invitation product definition configured in a first storefront according to one embodiment of the present invention.

FIGS. 4B-4J are diagrams illustrating exemplary information about the structure and printable content of the product of FIG. 4A.

FIG. 5 is a diagram illustrating an exemplary product definition configured in a second storefront by inheriting from a product definition in a first storefront according to one embodiment of the present invention.

FIG. 6 is a diagram illustrating an exemplary product definition configured in a second storefront in relation to a product definition in a first storefront according to other embodiments of the present invention.

FIG. 7 is a diagram illustrating an exemplary time sequence for configuring a child product by inheriting according to one embodiment of the present invention.

FIG. 8 is a diagram illustrating an exemplary time sequence for ordering a child product through a network of storefronts according to one embodiment of the present invention.

FIG. 9 is a diagram illustrating an exemplary user interface for browsing products in a print community according to one embodiment of the present invention.

FIG. 10 is a diagram illustrating an exemplary time sequence for ordering a product from a print community according to the present invention.

### DETAILED DESCRIPTION OF THE INVENTION

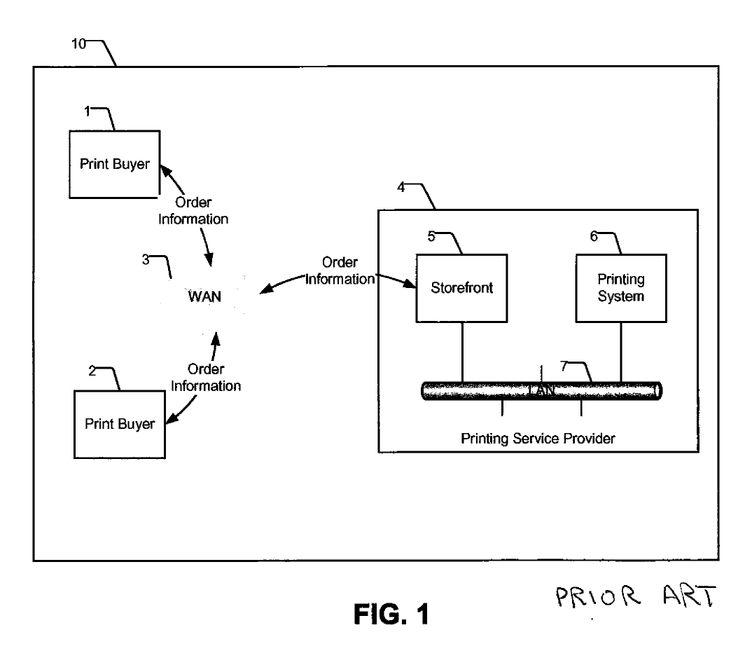

FIG. 1 is a diagram illustrating an exemplary prior art system 10 for automated printing. System 10 is consistent, for example, with the commonly assigned references identified above. In summary, a print buyer 1 or 2 uses a client computer at an arbitrary location to access printing service provider 4 through wide area network 3 to order printed products. Printing service provider 4 can include, for example, a computerized storefront 5 for communicating with print buyer 1 or 2 to perform print order transactions. Printing service provider 4 can also include, for example, a computerized printing system 6, in communication with storefront 5 through local area network 7. Printing system 6 accepts confirmed orders taken by storefront 5 and processes them to produce the desired printed material which can then be delivered to print buyer 1 or 2. Storefront 5 and printing system 6 are preferably designed and configured with a high degree of coupling to enable an order to be automatically processed.

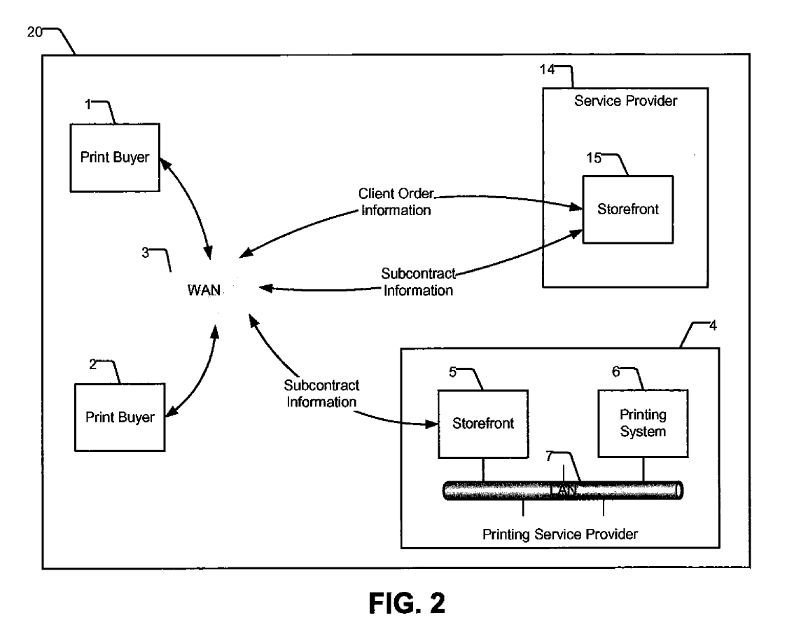

FIG. 2 is a diagram illustrating an exemplary network 20 of storefronts according to one embodiment of the present invention. Network 20 enables a service provider 14, having limited printing facilities, and a printing service provider 4, having automated printing capacity, to provide additional competitive services to print buyers 1 or 2 without incurring significant additional setup or transactional costs.

Service provider 14, for example, may have a significant catalog of print product items and/or a significant pool of potential clients. The catalog of service provider 14 can be defined in storefront 15 but service provider 14 may not be able to produce these items at reasonable cost without an automated printing solution. Conversely, printing service provider 4 may have a limited catalog and/or client base but is able to automatically and efficiently produce those printed products. Previously, a manual and error-prone process of transferring order details from storefront 15 to storefront 5 might be required. As one alternative, custom software could be developed to automate the order transfer process which could require ongoing adjustment as product definitions change. As another alternative, storefronts 5 and 15 could be configured, through a laborious and error-prone process, so that their product definitions mirror each other to allow print orders received at storefront 15 to be easily processed at storefront 5.

According to one aspect of the present invention, a second print product can be defined in storefront 15 in relation to a first print product definition configured in storefront 5. In a preferred embodiment, configuring the second product includes inheriting from the first product. For the purposes of this application, inheriting means receiving and automatically reusing the product definition from a different storefront. As described in more detail below, reuse may be partial with certain parts of a product definition having limited availability or certain parts of a product definition modified by a storefront that is inheriting the product definition. By inheriting the product definition, their definitions are linked and consistency between the child and parent product definitions is ensured. Further, the cost of configuring a child product definition is reduced to a minimum as dictated by the desired difference in its characteristics, relative to the parent product.

To further illustrate this aspect of the present invention, a more detailed example of inheriting product definitions is now described. Product definition can include several categories of information. One category, for example, can include information capturing the intent of print buyer 1 or 2. Another exemplary category can include information about the structure and content of the print product. Another exemplary category can include information used to determine a price for an order. These categories of information can be configured in storefront 5 as an example. Another exemplary category of information is print production rules used by printing system 6 to automatically produce the printed material from a confirmed order.

Assume, for this example, that an invitation product is defined by printing service provider 4. This invitation product is defined to be relatively general with all printable content to be supplied with the order and having optional RSVP and envelope parts.

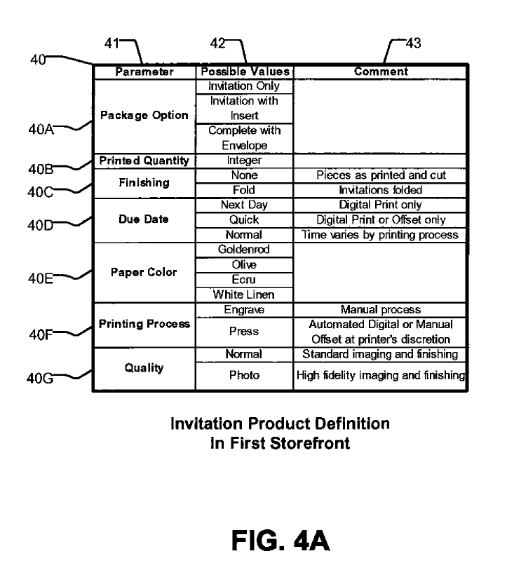

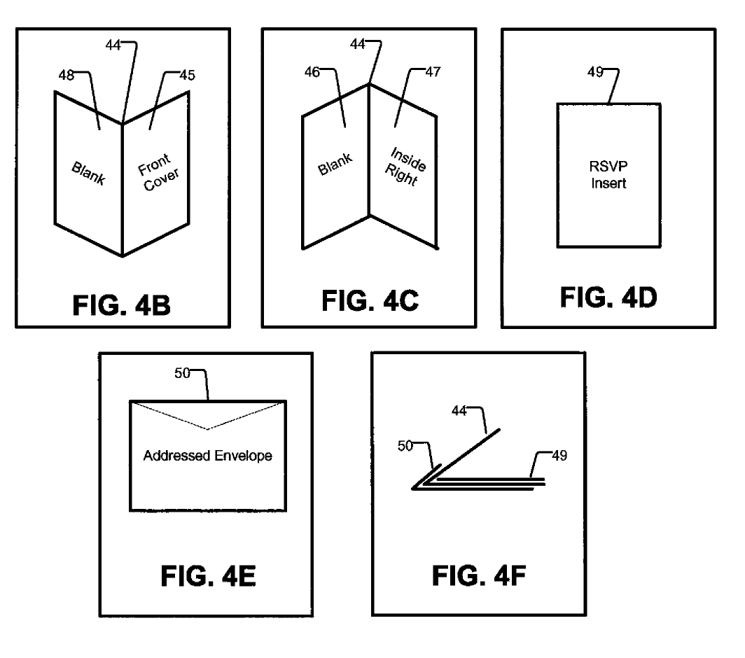

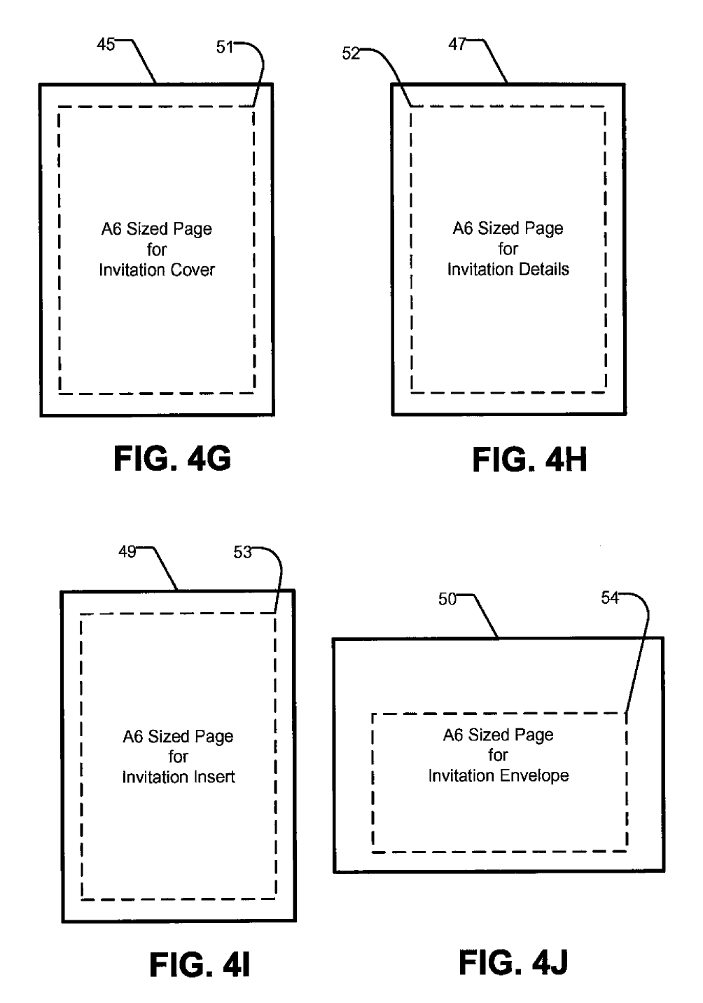

FIG. 4A is a diagram illustrating exemplary printing intent information defined in storefront 5 for this invitation product. Printing intent can be configured as a data schema including a set of printing intent parameters 40 whose values are specified by print buyer 1 or 2 when placing an order. Each printing intent parameter 40 is configured with a parameter name 41. Possible parameter values 42 can be configured for each printing intent parameter 40 to describe the range of choices that print buyer 1 or 2 can make. Parameter comments 43 can also be configured to provide a print buyer with descriptive information regarding a parameter or value. In this example, printing intent parameters 40A-40G are configured as shown and allow print buyer 1 or 2 to specify various optional packages, quantities and process options for an invitation.

FIGS. 4B-4J are diagrams illustrating exemplary information about the structure and printable content of the product of FIG. 4A. FIGS. 4B and 4C illustrate the structure of basic invitation 44, indicating that it is folded with content supplied on two of four pages 45-48. FIGS. 4D-4E illustrate optional parts which may be ordered, including an RSVP insert 49 and an addressed envelope 50. FIG. 4F illustrates an optional finishing arrangement including assembled invitation parts. FIGS. 4G-4J illustrate information about the printable content for the invitation. In particular, there is no predefined content for the product. However, specifications for the size and the relative positioning of placeholders 51-54 for client-supplied content is illustrated. This structure and content information can be configured in storefront 5 as parameters or graphically or some combination of these or other methods. A representation of this information, can be presented to print buyer 1 or 2 to clarify what is being ordered. These representations can also incorporate buyer-supplied content to help visualize the finished product.

A print pricing model can also be configured in storefront 5 for the invitation product based at least in part on the set of printing intent parameters 40. For clarity an exemplary print pricing model is not presented here. Refer to commonly-assigned U.S. patent application Ser. No. 11/678,250 for a more detailed discussion of print pricing models based on printing intent parameters.

Print production rules for automating production can also be configured in printing system 6 for the invitation product based at least in part on the set of printing intent parameters 40. For clarity exemplary print production rules are not presented here. Refer to commonly-assigned U.S. patent application Ser. No. 11/538,937 for a more detailed discussion of print production automation based on rules.

Having configured the parent invitation product in storefront 5, service provider 14 can configure storefront 15 to create a child invitation product by inheriting from the parent invitation product defined in storefront 5. Assume, for our example, that service provider 14 intends to create a simpler invitation product where fewer options are provided and print buyer 1 or 2 is only required to personalize a portion of the printable content (e.g. text). Storefront 15 communicates with storefront 5 to obtain product definition information from storefront 5. This communication can occur as a result of steps taken while configuring the child product. Alternatively, storefront 15 can obtain product information from storefront 5 from time to time and make that information available for selection to an administrator of storefront 5.

In one preferred embodiment, a child product is initially configured to be identical to the parent product based on the information supplied by storefront 5. The user of storefront 15 then proceeds to specialize the definition based on the custom requirements of the child product. In other embodiments, other automated methods can be used to configure the child product. For example, the user can be led through a definition process using the parent definitions as a guide.

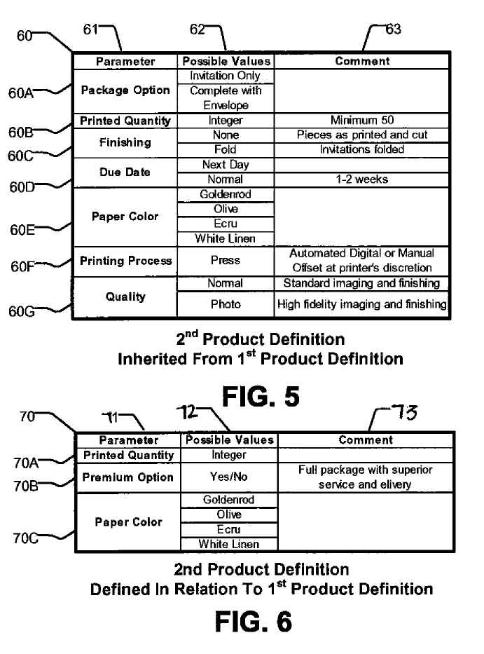

FIG. 5 is a diagram illustrating a portion of an exemplary production definition configured in a second storefront 15 by inheriting from a product definition in a first storefront 5 according to one embodiment of the present invention. In particular, FIG. 5 illustrates a set of printing intent parameters 60; including parameter name 61, parameter value 62, and parameter comments 63; for a child product created by inheriting from the set of printing intent parameters 40 defined by storefront 5. Requirements for the child product, in this example, include further limiting the range of possible values 62 for parameters 60A, 60D and 60F. This customization of printing intent may be done, for example, to eliminate options that have cost, quality, timing, packaging, delivery or other characteristics that might not be desirable to service provider 14.

Similarly, the information about the structure and the content of the invitation product has been inherited (not shown). In this example, the structure information is retained but the content information has been customized. Assume, for example, that one or more content templates, such as Adobe® InDesign® templates, have be configured in association with each of placeholders 51-54 in the child product definition. Templates for various styles of invitations (e.g. birthday, wedding) may have been defined to simplify the task of print buyer 1 or 2 to selecting the appropriate template and then providing additional content. Different templates can allow for different levels of personalization to suit the needs of print buyer 1 or 2. For example, a simplifying template may only require print buyer 1 or 2 to supply textual information (e.g. name and address information). As another example, a more flexible template may provide example artwork, images and text but allow print buyer 1 or 2 to substitute or edit certain items as desired. This customization of content information may be done, for example, to differentiate service provider 14 or to meet the specific needs of their existing client base.

Similarly, the information used to determine the price of an order has been inherited (not shown) and may be customized. Here, a number of potential embodiments are possible. In one embodiment, the pricing model from storefront 5 can be provided to storefront 15 for retention or customization. This is simplest from the perspective of service provider 14 but may provide unwanted visibility to sensitive pricing information configured by printing service provider 4. Accordingly, in some embodiments, no pricing information can be inherited or can be inherited at the discretion of the of the printing service provider 4. In this case, service provider 14 must configure pricing independently.

In another embodiment, the structure of the child pricing model can be inherited from the parent but with sensitive pricing information excluded. This will require some price configuration by service provider 14. In another embodiment, no child pricing model need be configured. Instead baseline pricing can be provided by printing service provider 4 directly and service provider 14 can then either pass this pricing on or configure a simple model, such as an incremental per-order or per-unit price, for adapting the parent prices for the child product.

In another embodiment, where the model is based on a spreadsheet, inheriting can include linking parts of a child pricing model to the parent pricing model, but without visibility of the parent model, so that any changes in parent pricing are automatically reflected in the child model. For example, for each pricing parameter or factor identified by printing service provider 4 in the parent spreadsheet, additive and/or multiplicative factors can be configured in the child pricing spreadsheet which are applied to the linked parent spreadsheet. Thus, for example, a parent pricing factor can be increased (e.g. add an amount or multiply by an amount) or can be replaced (e.g. multiple by zero and add a desired amount). This method also allows provider 4 to obscure or completely hide parts of the parent pricing model from service provider 14.

FIG. 6 is a diagram illustrating an exemplary product definition configured in a second storefront in relation to a product definition in a first storefront according to other embodiments of the present invention. In these embodiments, a different set of printing intent parameters 70 can be configured for a second product in relation to the printing intent parameters 40 for a first product. This may be done, for example, to further differentiate the second product from the first product. In one embodiment, configuring the second product can occur manually so that an order for the second product can be automatically converted into an order for the first product. In a preferred embodiment, the second product can be configured by inheriting from the first product so that the second product is a child of the first product.

In an inheriting embodiment, service provider 14 can inherit the parent product definition and envelope it with product printing intent parameters 70 as shown. This will require service provider 14 to configure a logical mapping between printing intent parameters 70 and printing intent parameters 40. For example, printing intent parameters 70A and 70C can be automatically mapped directly to parameters 40B and 40E respectively based on consistency between parameter names 41 and 71 and/or possible values 42 and 72. Printing intent parameter 70B can then be manually mapped to printing intent parameters 40A, 40C, 40D, 40F and 40G. As an example, a value of “yes” for printing intent parameter 70B can be configured to map to values of: “complete with envelope” for printing intent parameter 40A; “fold” for printing intent parameter 40C; “next day” for printing intent parameter 40D; “press” for printing intent parameter 40F; and “photo” for printing intent parameter 40G. Similarly, a value of “no” for printing intent parameter 70B can be configured to map to the default values for printing intent parameters 40A, 40C, 40D, 40F and 40G.

Inheriting of information about structure and content as well as pricing can occur as described above in relation to FIG. 5. Pricing information can be based on the parent printing intent parameters 40 or can be based on printing intent parameters 70 instead. In the latter case, however, the potential for child and parent products to diverge exists. Parameter comments are at column 73.

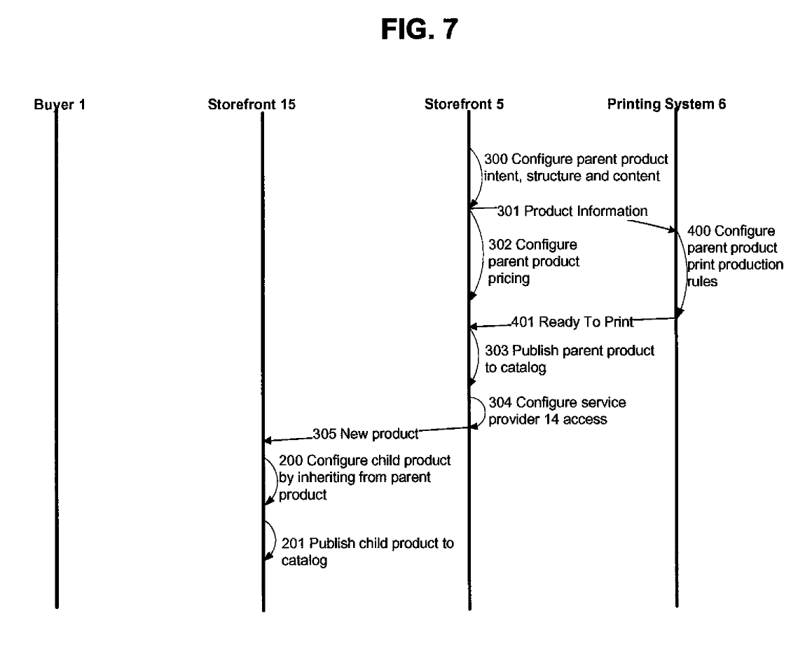

FIG. 7 is a diagram illustrating an exemplary time sequence for configuring a product by inheriting according to one embodiment of the present invention. In particular, FIG. 7 depicts actors of FIG. 2 and selected steps they perform as the exemplary child product of FIG. 5 is configured by inheriting from the exemplary parent product of FIGS. 4A-4J.

Storefront 5 begins at step 300 with printing service provider 4 configuring the parent product definition. For example, printing intent parameters 40 are defined along with information about the structure, content, and pricing 302 of the parent product. Next, at step 301, information about the parent product is automatically transmitted to printing system 6 when the parent product configuration is complete.

Proceeding at step 400, printing service provider 4 configures print production rules in printing system 6. Upon completion, and potentially testing, the rules are activated and at step 401, printing system 6 automatically transmits information to storefront 5 indicating that it is ready to process orders for the parent product.

Proceeding at step 303, printing service provider 4 publishes the parent product to a catalog that is accessible to at least some of its clients. Print buyer 1 may or may not be configured as a client having access to the parent product. If configured for access, then print buyer 1 can then submit orders for the parent product directly to storefront 5.

At step 304, which may be earlier or later (as shown) for example, storefront 5 is configured to allow storefront 15 access to storefront 5. This configuration can include establishing a user account and privileges along with billing information, pricing information (e.g. discounts) and the like so that storefront 15 can directly order products configured on storefront 5.

Next at step 305, which may also occur upon completion of step 303 for a storefront already configured for access to storefront 5, information about the parent product is transmitted to storefront 15. The information can include some or all of the information necessary to configure a child product by inheriting from the parent product. For example, only the name of the parent product and some descriptive information may be transmitted and additional information can be requested as needed during configuration of a child product. As another example, this step can be omitted and storefront 15 can dynamically query storefront 5 for information about any product enabled for inheritance.

Next at step 200, service provider 14 determines the need for a child product based on the parent product and configures the child product as described above. In some embodiments, storefront 15 is able to test submission of orders to storefront 5 to verify the configuration and dependencies between the child and parent products without billing storefront 5 and without initiating production by printing system 6. Test-mode processing by these systems may be desirable to verify different facets such as pricing and content.

At step 201, upon configuration and testing of the child product, service provider 14 publishes the child product to a catalog so that at least print buyer 1 can order the child product.

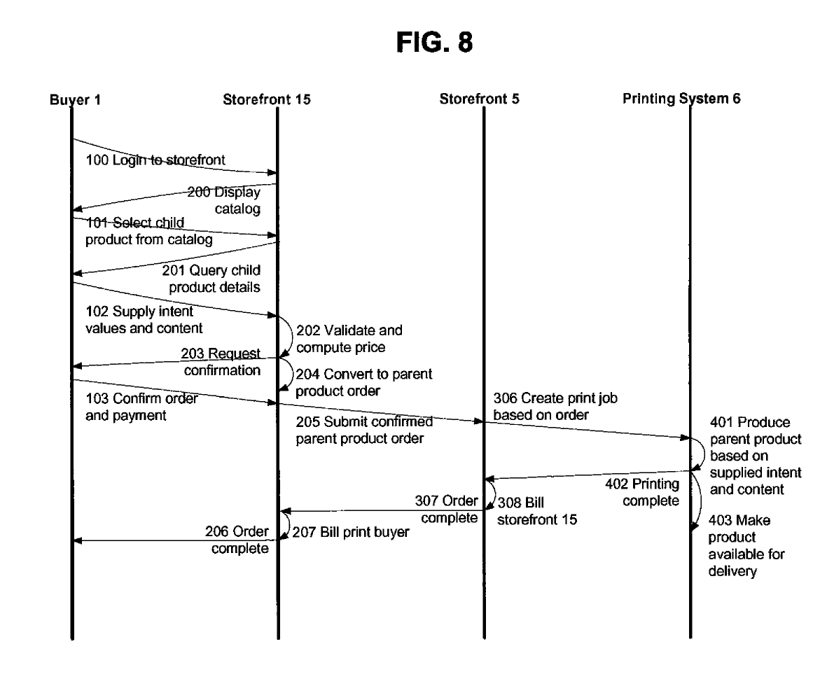

FIG. 8 is a diagram illustrating an exemplary time sequence for ordering the child product configured in FIG. 7 through a network of storefronts according to one embodiment of the present invention. Print buyer 1 begins at step 100 by logging in to storefront 15 as an existing client. In some embodiments, client access to a storefront 5 or 15 may be provided through guest accounts or without access controls. Instead, a process for confirming a client's ability to pay (e.g. through credit card authorization) may be a substitute for some access controls.

Next at step 200, storefront 15 presents a catalog of orderable products to print buyer 1 for selection. At step 101, print buyer 1 selects the child product described above. At step 201, storefront 15 queries print buyer 1 to provide details about the order. At step 102, print buyer 1 provides the details, including at least printing intent parameter values, to storefront 15. For the example child product, print buyer 1 also provides some content details (e.g. text) to be merged by storefront 15 with at least one content template associated with the child product. Steps 101 and 102 may occur as a series of related exchanges of information, rather than exactly as shown.

Next at step 202, upon receipt of the necessary intent and content information, storefront 15 validates the information (e.g. content is consistent with the intent) and computes a price for the potential order. Next at step 203, a request to confirm the order is transmitted to print buyer 1 that includes at least the computed price. At about the same time as step 203, storefront 15, at step 204, derives an order for the parent product based on the information provided by print buyer 1 for the child product. This can include generating appropriate parent printing intent values and creating content required for the parent (e.g. merging templates and personalization information) as an example.

Next at step 103, after receiving the request to confirm from storefront 15, print buyer 1 considers the price, identifies payment information, and transmits confirmation for the order for the child product to storefront 15. Upon receipt of the confirmation, storefront 15, at step 205, transmits the previously derived order for the parent product to storefront 5 as a confirmed order. Upon receipt of the confirmed parent order, storefront 5, at step 306 transmits a request to create an automated print job based on the order to printing system 6.

At step 401, printing system 6 creates the print job and begins automated processing based on the received printing intent and content along with the pre-configured print production rules. Printing system 6, storefront 5 and storefront 15 may also provide order status information back to their respective clients. Not all status indications are shown, but upon completion of the production process, at step 402, printing system 6 indicates that printing is complete. Coincident to this, printing system 6 performs other operations necessary to make the finished parent product available for delivery 403 to print buyer 1. Similarly, upon receipt of completion status, storefront 5 bills storefront 15 at step 308, storefront 5 provides notification to storefront 15 at step 307, and storefront 15 notifies print buyer 1 about completion at step 206 and also bills print buyer 1 at step 207.

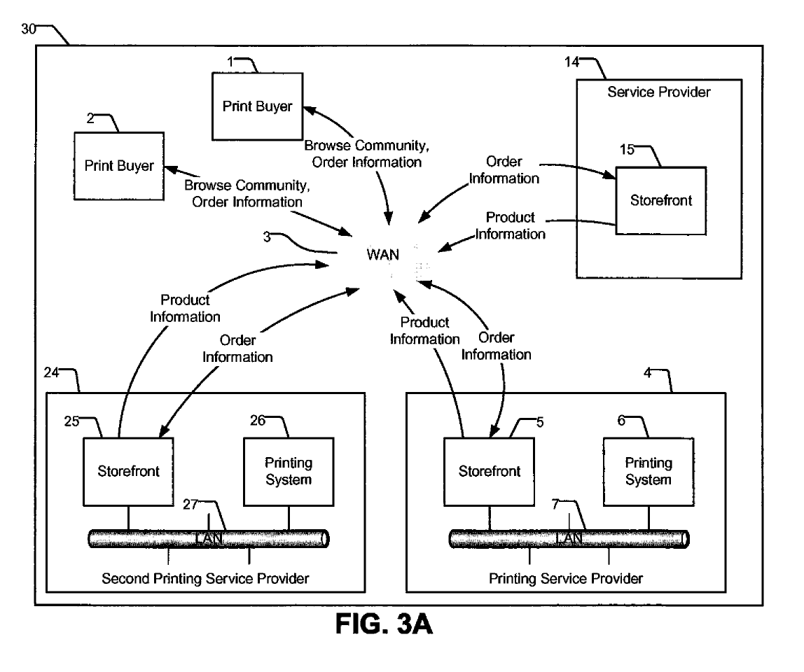

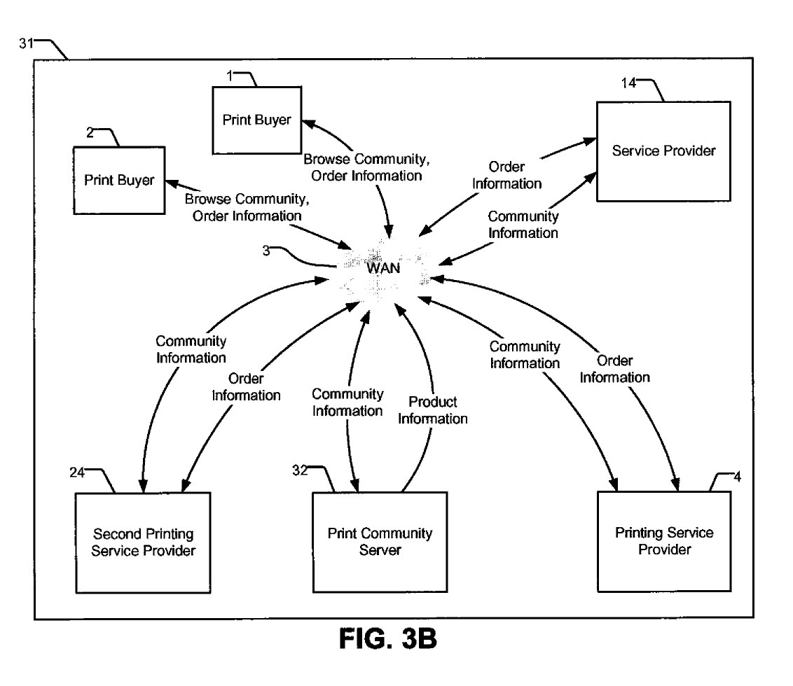

An additional aspect of networked storefronts can be described with reference to FIG. 3A. FIG. 3A is a diagram illustrating an exemplary network of storefronts 5, 15, and 25 operating as part of a print community 30 according to one embodiment of the present invention. FIG. 3A depicts a second printing service provider 24 that operates a storefront 25, LAN 27, and printing system 26. Printing service provider 24 offers printed products that may overlap with those offered by printing service provider 4 and may be offered at different prices or with other differentiating aspects. Providers 4, 14, and 24 can configure their respective storefronts 5, 15, and 25 to join print community 30 to enable a client of any storefront (e.g. print buyer 1 of storefront 15) to browse and order products from catalogs published by any of the storefronts 5, 15, and 25 to print community 30.

A plurality of print communities can be established. For example, distinct communities may be based on geography, providers, clients, type of work, or other characteristics. Storefront 5, 15, and 25 can be individually configured to join one or more of the plurality of print communities.

According to one embodiment, when print buyer 1 or 2 browses print community 30, each storefront 5, 15, and 25 in print community 30 receives a request and responds with product information based on the request. A number of communication methods, such as hub-spoke and peer-to-peer, are known in the art for accommodating this type of communication.

Service providers 4, 14, and 24 can establish limits on their participation in print community 30 upon or after joining print community 30. For example, selected products can be published to print community 30. This might be necessary, for example, to maintain confidentiality or a competitive advantage. As another example, characteristics of products (e.g. pricing information, printing intent choices, delivery methods) can be changed when offered through print community 30. This can be accomplished, for example, by creating child product definitions with altered characteristics for use through print community 30.

Storefronts 5, 15, and 25 can also provide information related to interactions within print community 30. This information can be stored and used to generate reports that may help service providers 4, 14, and 24 refine their private and community offerings. Exemplary report information for a period of time can include: the number of search requests received by a storefront; the distribution of search requests received by a storefront based on some search characteristic (e.g. a set of search keywords); the number of search requests matching products offered by a storefront (e.g. in private or community catalogs); the number of searches resulting in an inquiry to a storefront (e.g. a browse of the product details or a partially completed order); the number of searches resulting in a completed order with a storefront; and the distribution of completed orders in the community based on some characteristic such as geography, provider-affiliation, and product characteristic.

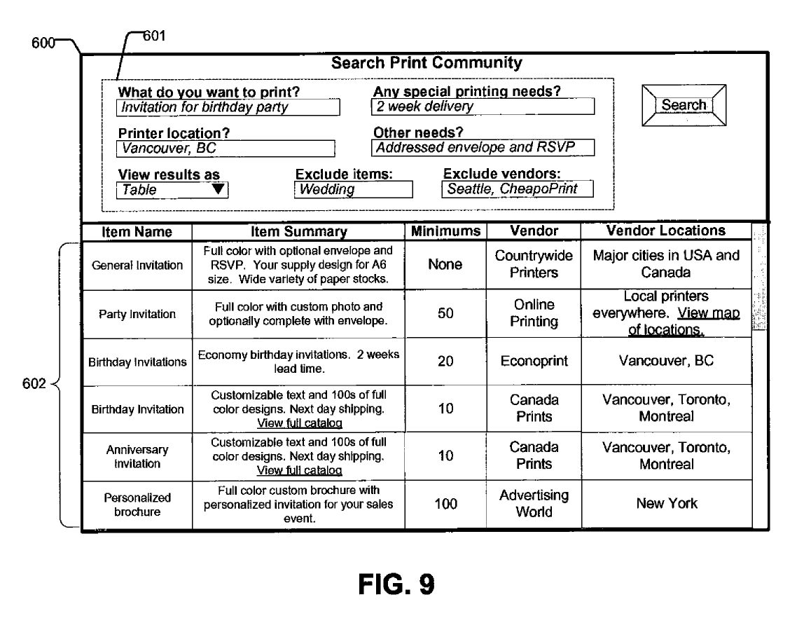

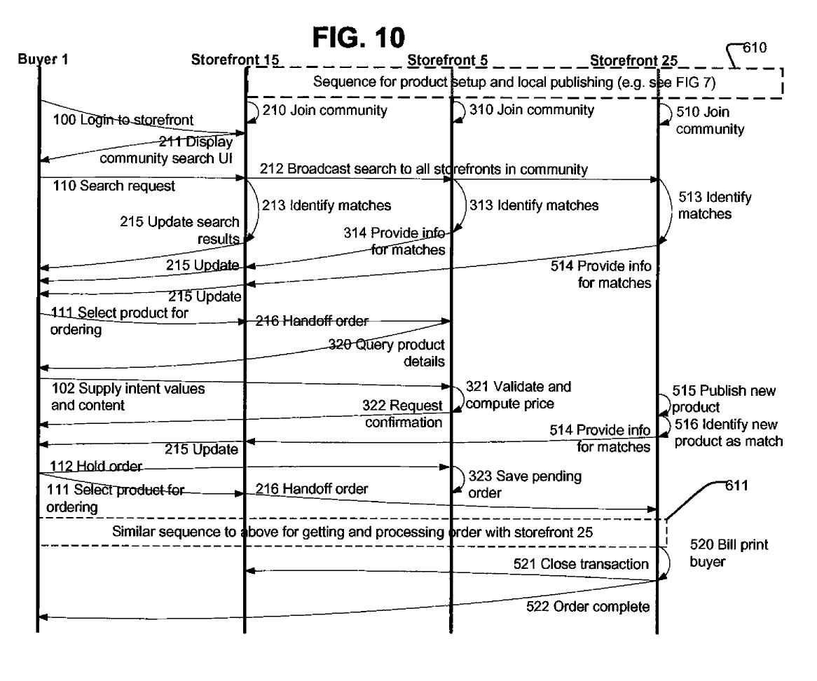

FIG. 9 is a diagram illustrating an exemplary user interface 600 for browsing products in print community 30 according to one embodiment of the present invention. Each storefront 5, 15 and 25, upon joining a print community 30, can provide user interface 600 to a client. User interface 600 includes a search area 601 for specifying characteristics of the product of interest. Exemplary search characteristics and client values are illustrated for search area 601. For example, a print buyer may wish to exclude certain vendors or consider vendors based on their locations or areas served.

Search results area 602 presents an exemplary display of summary product information received from storefronts in print community 30 based on the search characteristics. Summary information for a product can be selected through user interface 600, for example, to obtain additional information or to begin the order entry process. Presentation of information can take many forms. Exemplary forms include tabulated summary form (as shown), detailed form (not shown), and vendor location on map form (not shown).

FIG. 10 is a diagram illustrating an exemplary time sequence for ordering a product from print community 30 according to the present invention. In particular, FIG. 10 depicts actors of FIG. 3A and steps they perform as print buyer 1 searches for and orders products. The sequence begins at block 610, representing a sequence of steps where storefronts 5, 15, and 25 configure products similar to the sequence described in FIG. 7. Assume at this step that each storefront has configured one or more invitation products including perhaps those configured by inheriting from products configured in other storefronts which may or may not be part of print community 30.

Next at steps 210, 310, and 510, storefronts 15, 5 and 25 respectively join print community 30 and configure their systems in relation to print community 30. For example, assume that storefronts 15 and 5 have published their invitation products to the community but storefront 25 has not. Note that when publishing products to print community 30, a storefront may need to supply additional associated information to help print buyer 1 or 2 make an informed selection. For example, information about a service provider offering a product, subcontractors associated with printing the product, geographical locations served by the service providers and subcontractors and other related information may need to be supplied.

Next at step 100 print buyer 1 logs in to storefront 15 where, for example, he has established personal and/or financial credentials. Then, at step 211, storefront 15, either automatically or based on input from print buyer 1, presents search user interface 600. At step 110, print buyer 1 supplies search criteria to storefront 15, which in turn broadcasts the request at step 212 to all other storefronts in the community. As mentioned above, there are many potential communication and synchronization embodiments possible for this and other steps in the sequence. For clarity, only one exemplary embodiment is presented here.

Next at steps 213, 313, and 513, storefronts 15, 5, and 25 respectively identify any products that match the search criteria. Storefronts 5 and 25 respond to storefront 15 at steps 314 and 514 respectively with information for any matching products, which at this point includes matches only from storefront 5. Storefront 15 responds by sending updated information to search results area 602 at steps 215 as each matching product information is received.

Next at step 111 print buyer 1 selects one of the matching products from search results area 602 and initiates the order process. Assume that the selected product was one offered by storefront 5. Storefront 15 receives the request and at step 216, hands off the order request to storefront 5. Storefront 5 responds at step 320 by querying product details from print buyer 1.

According to one embodiment, at this point, print buyer 1, who may not normally have direct access to storefront 5, can be interacting directly with storefront 5. This can be accomplished for example, by storefront 15 providing proxy access to storefront 5. Access to storefront 5 can be restricted by storefronts 5 and/or 15. For example, access can be restricted to a current transaction or to a session or by a purchase amount. In other embodiments (not shown) storefront 15 can act as a proxy for storefront 5 so that print buyer 1 is interacting directly with storefront 15 and storefront 15 submits a print order to storefront 5 on behalf of print buyer 1.

Assuming the first embodiment, print buyer 1 responds, for example at step 102, by supplying printing intent values and content to storefront 5, which in turn validates and prices the order at step 321 and requests order confirmation at step 322. Meanwhile, assume that printing service provider 24 has decided to publish a number of products to the community at step 515. This includes at least one invitation product, which is identified as matching a recent search request at step 516. In response, storefront 25 provides the matching product information at step 514 to storefront 15. Storefront 15, in turn, provides an update to search results area 602 at step 215.

Print buyer 1 notices the updated search results area 602 and places a hold on the order with storefront 5 at step 112, and saves the pending order 323. Print buyer 1 then selects the new product for ordering at step 111 and storefront 15 hands off the order to storefront 25 in response at step 216. Next at block 611, representing a sequence of steps where print buyer 1 and storefront 25 establish a confirmed order similar to the steps described above and in FIG. 7.

Next, at step 520, storefront 25, upon receiving a printing complete indication from printing system 26, bills print buyer 1. In addition, storefront 25, at step 521 notifies storefront 15 that the transaction has closed. Closing a transaction can trigger a financial transaction, such as storefront 15 billing storefront 25 for a commission. It may also trigger closing any pending transactions, such as the one on hold with storefront 5.

Finally at step 522, storefront 25 notifies print buyer 1 of the order completion. This can occur, for example, as an email or a notification directly from storefront 25 or through storefront 15.

In some embodiments, search area characteristics 601 can be used to influence subcontracting arrangements. For example, if storefront 25 subcontracts fulfillment of the ordered product, two or more subcontracting storefronts, located in different cities, can be identified and one can be chosen based on information supplied in the search characteristics 601 (e.g. printer location).

FIG. 3B is a diagram illustrating another exemplary print community embodiment. In this embodiment, print community 31 includes a print community server 32 which is used to facilitate the administration and operation of print community 31. For example, print community server 32 can maintain information related to the structure and status of print community 31 and provide access to information related to print community 31, such as product information and interaction information. As another example, print community server 32 can host user interface 600 directly and handoff an order request to a community storefront in a manner similar to that described above.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### PARTS LIST

1 print buyer
2 print buyer
3 wide area network
4 printing service provider
5 storefront
6 printing system
7 local area network
10 system
14 service provider
15 storefront
20 network of storefronts
24 printing service provider
25 storefront
26 printing system
27 local area network
30 print community
31 print community
32 print community server
40 printing intent parameter
40A-40G printing intent parameter
41 parameter name
42 possible parameter values
43 parameter comments
44 invitation
45 invitation front page
46 invitation inside left page
47 invitation inside right page
48 invitation back page
49 RSVP insert
50 addressed envelope
51 placeholder
52 placeholder
53 placeholder
54 placeholder
60 printing intent parameter
60A-60G printing intent parameter
61 parameter name
62 possible parameter values
63 parameter comments
70 printing intent parameter
70A-70C printing intent parameter
71 parameter name
72 possible parameter values
73 parameter comments
100 login to storefront
101 select child product from catalog
102 supply intent values and content
103 confirm order and payment
110 search request
111 select product for ordering
112 place hold on order with storefront
200 configure child product by inheriting from parent product
201 publish child product to catalog
202 validate and compute price
203 request confirmation
204 convert to parent product order
205 submit confirmed parent product order
206 order complete
207 bill print buyer
210 storefront joins print community
211 display search community user interface
212 broadcast search to all storefronts in community
213 identify matches
215 send updated information to search results area
216 handoff order request to storefront
300 configure parent product intent, structure, and content
301 information about parent product transmitted to printing system
302 configure parent product pricing
303 publish parent product to catalog
304 configure service provider access
305 information about parent product transmitted to storefront
306 create print job based on order
307 order complete
308 bill storefront
310 storefront joins print community
313 identify matches
314 provide information for matches
320 query product details
321 validate and compute price
322 request order confirmation
323 save pending order
400 configure parent product print production rules
401 printing system transmits information to storefront
402 printing complete
403 make product available for delivery
510 storefront joins print community
513 identify matches
514 provide information for matches
515 publish new product to community
516 identify new product as match
520 bill print buyer
521 close transaction
522 order complete
600 user interface
601 search area
602 search results area
610 sequence for product setup and local publishing
611 sequence where print buyer and storefront confirm order

1. A method for printing, the method comprising:
configuring a plurality of storefronts to join a print community wherein each storefront provides an interactive product ordering service for print buyers;
a print buyer specifying characteristics of a desired product through an interface to the print community;
obtaining information from the plurality of storefronts of the print community wherein the information includes information about products matching the characteristics of the desired product;
determining the products matching the characteristics of the desired product based on the information from the plurality of storefronts of the print community;
presenting the print buyer with information about the products matching the characteristics of the desired product;
wherein the print buyer selects a product based on the information about the products;
wherein the print buyer orders the product from at least one storefront of the print community; and
a printing system for printing the product from at least one storefront of the print community based on the order.

2. A method according to claim 1 wherein configuring a storefront to join the print community comprises enabling transmission of product characteristics, offered by the storefront, to the print community.

3. A method according to claim 2 wherein configuring a storefront to join the print community comprises establishing limits on products offered through the print community.

4. A method according to claim 3 wherein establishing limits on products offered through the print community comprises one or more of:
selecting a subset of the products to be offered through the print community; and
altering a characteristic of a product offered through the print community.

5. A method according to claim 2 wherein specifying characteristics of the desired product also comprises specifying one or more of the following:
a characteristic of a service provider offering the desired product; and
a characteristic of a location served by the service provider offering the desired product.

6. A method according to claim 1 wherein the interface to the print community comprises a storefront of the print community.

7. A method according to claim 1 wherein the interface to the print community comprises an administrative server of the print community.

8. A method according to claim 1 wherein the plurality of storefronts are operated by a plurality of service providers and wherein access to a storefront by a print buyer depends upon configuring access to the storefront for the print buyer.

9. A method according to claim 8 wherein configuring a storefront to join the print community comprises enabling the interface to the print community at least partial access to storefronts in the print community.

10. A method according to claim 9 also comprising the print buyer selecting a product offered by one of the plurality of storefronts.

11. A method according to claim 10 wherein selecting the product also comprises:
the interface to the print community automatically providing proxy access to the storefront; and
the print buyer ordering directly through the storefront.

12. A method according to claim 10 wherein the interface to the print community is a first storefront of the print community and wherein selecting the product also comprises the first storefront placing an order for the selected product with one of the other storefronts on behalf of the print buyer.

13. A method according to claim 10 wherein selecting the product offered by the one of the plurality of storefronts comprises storing, in the print community, information related to selecting the product.

14. A method according to claim 13 also comprising generating a report based on the information related to selecting the product.

15. A method according to claim 1 also comprising storing information related to determining the products matching the characteristics of a desired product.

16. A method according to claim 15 also comprising generating a report based on the information related to the search for products matching the characteristics of a desired product.

17. A print ordering apparatus comprising:
a plurality of storefronts each operative to:
independently provide an interactive product ordering service for print buyers; and
join a print community whereupon joining the print community a storefront is also operative to:
provide information about products orderable through the print community;
provide a print buyer an interface for specifying characteristics of a desired product;
obtain information from a plurality of storefronts of the print community wherein the information includes information about products matching the characteristics of a desired product;
determine the products matching the characteristics of a desired product based on the information from the plurality of storefronts of the print community;
present the print buyer with information about products matching the characteristics of a desired product; and
cooperate with another storefront to process an order for a product orderable through the print community.

18. A print ordering apparatus comprising:
at least one print community server operative to:
maintain information about a storefront that has joined the print community;
provide a print buyer an interface for specifying characteristics of a desired product;
obtain information from a plurality of storefronts of the print community wherein the information includes information about products matching the characteristics of a desired product;
determine the products matching the characteristics of a desired product based on the information from the plurality of storefronts of the print community;
present the print buyer with information about the products matching the characteristics of a desired product; and
cooperate with a storefront of the print community to process an order for a product identified by the storefront; and
a plurality of storefronts each operative to:
independently provide an interactive product ordering service for print buyers; and
join a print community whereupon joining the print community a storefront is also operative to:
provide information about products orderable through the print community; and
cooperate with a print community server to process an order for a product identified to the print community.

19. A medium carrying program code for executing the method according to claim 1.
